(19) United States
(12) Patent Application Publication
(10) Pub. No.: US 2013/0120997 A1
(43) Pub. Date: May 16, 2013

(54) APPARATUS AND METHOD FOR DIFFUSING LIGHT BY RETROFITING PRE-EXISTING LIGHT FIXTURES

(71) Applicant: Mitchell Teller, Brooklyn, NY (US)

(72) Inventor: Mitchell Teller, Brooklyn, NY (US)

(21) Appl. No.: 13/679,067

(22) Filed: Nov. 16, 2012

Related U.S. Application Data
(60) Provisional application No. 61/560,495, filed on Nov. 16, 2011.

(51) Int. Cl. F21V 3/04; F21V 5/00; F21V 7/00

(52) U.S. Cl. CPC F21V 3/049; F21V 7/00; F21V 5/00
USPC 362/256; 362/255

(57) ABSTRACT

This specification describes technologies relating to the modification of pre-existing light fixtures such that the fixtures produce diffuse indirect lighting instead of direct lighting. Implementation of said technology comprises: a modular apparatus that attaches to pre-existing light fixtures to convert direct lighting into diffuse indirect lighting, and a method by which said apparatus is used for said purpose. Said technology enhances the aesthetics of an artificially illuminated environment and increases the comfort of users in said environment. Compared to alternative implementations comprising light fixture replacement, the technology specified herein presents reduced time, money, and skill barriers for users, is highly modular for simple user customization, and can be cleanly installed, adjusted, and removed without damage to the pre-existing light fixture, the attachment surface, or the apparatus.

### CROSS-REFERENCE TO RELATED APPLICATIONS

This application is a utility conversion of Provisional Application Ser. No. 61/560,495, filed on Nov. 16, 2011. The disclosure of U.S. Provisional Patent Application No. 61/560,495 is incorporated herein by reference in its entirety.

### TECHNICAL FIELD

This invention relates to light fixtures, and more specifically to the modification of pre-existing light fixtures in order to alter the properties of the light produced by the fixture from direct lighting to diffused lighting.

### BACKGROUND

In a typical residential or commercial indoor environment, illumination is often provided by overhead installations. A common configuration comprises an exposed light bulb held in a recessed overhead fixture, commonly referred to as a “can” light. Such light fixtures are cost effective, easy to install, and easy to maintain, but will typically provide undesirably harsh and uneven direct light. Direct light emphasizes imperfections in appearance, highlights shadows and washes out color differentiation.

In an indoor environment, diffuse light is often preferable to direct light. Compared to direct light, diffuse light results in softer, more even illumination and reduces undesirable glare. Diffuse light can increase the aesthetic qualities of the lit subject and its environment, and can improve the overall comfort of its users.

Preferential use of diffuse light instead of direct light has been demonstrated in professional fields, such as photography and videography. In these applications, direct light is passed through diffusive materials and/or reflected off white surfaces to soften the resulting illumination. This technique often contributes to a more flattering visual depiction of the subject and its environment, and can improve the overall aesthetics of a depicted scene.

Replacing or significantly altering pre-existing recessed light fixtures to provide diffuse light in a residential or commercial environment can be labor intensive, cost prohibitive, logistically challenging, and/or structurally impractical.

### SUMMARY

This specification describes technologies relating to the modification of pre-existing light fixtures such that the fixtures produce diffuse light instead of direct light. Implementations of the technology described herein comprise a modular light diffusing apparatus that attaches to pre-existing light fixtures and converts direct light into diffuse light, and a method by which the apparatus is used for diffusing light from pre-existing fixtures.

Various implementations of the present invention provide cost effective solutions to convert pre-existing household and/or commercial lighting fixtures into sources of diffuse light, without the significant time and monetary costs associated with light fixture replacement. Various implementations of the invention can be implemented quickly, require minimal pre-requisite skill from a user, and can be used in conjunction with a broad array of pre-existing light fixtures.

In one example implementation of the present invention, a light diffusion apparatus is attached to and positioned proximally about the lower portion of a pre-existing light fixture such that the attachment diffuses the light produced by that fixture. Various embodiments of the invention may include an attachment mechanism such that the apparatus can be secured to a pre-existing light fixture through non-destructive, fully reversible means, and the apparatus can be quickly installed, adjusted, and removed by the user with minimal skill requirement.

In general, one aspect of the subject matter described in this specification is the attachment mechanism of the light diffusing apparatus which may comprise a lower retention ring, an upper retention ring, and one or more retaining arms. In some embodiments the one or more retaining arms may be mechanically biased into a first position, the first position being different than a second installed position.

Another aspect of the subject matter described in this specification is the modularity of the light diffusing apparatus. The apparatus is comprised of several constituent elements, each of which may be replaced with alternative designs or removed entirely, depending on the user's application. Such modularity broadens the functionality and aesthetic versatility of the apparatus, and allows the apparatus to conform to the requirements of the user. Modular components can include, an upper ring, a lower ring, a diffusing disk insert, a perforated diffusing disc, a diffusing halo, a reflecting disk insert, a perforated reflecting disc insert, a reflecting halo, colored or tinted filters, opaque or partially translucent filters, and the like.

Another innovative aspect of the subject matter described in this specification is the apparatus' compatibility with a broad array of light fixtures. The apparatus can be readily adapted for use with a user's pre-existing light fixtures through user-replaceable elements.

In another example of the technology described herein and in order to diffuse light from a recessed overhead “can” light fixture, the components of the technology described herein may comprise light diffusive elements including diffusing and reflecting disks and halos, and attachment elements compatible with the pre-existing recessed light fixture including one or more ring mounts to receive the diffusing and reflecting disks and halos, a lower ring mount, an upper ring mount, one or more retention arms for attachment to the outer perimeter of the recessed fixture, and one or more spring or mechanically biased retention arms. The user may select modular constituent elements, such as components with light diffusive elements and components with attachment elements compatible with a can light. The user can assemble the apparatus from these components and secures it to the light fixture using the one or more retention arms.

In a further example, the apparatus may be modified from a diffusive apparatus to a reflective light apparatus, by removing the apparatus components with light diffusive elements, and replacing such diffusive components with light reflective elements.

In still a further example, the apparatus of the present invention can be modified such that the one or more retention arms are compatible with and fit a non-recessed, pre-existing light fixture, such as cylindrical track lighting. The one or more retention arms may attach to the front or back of the track lighting fixture.

Thus, the technology specified herein converts pre-installed or preexisting direct lighting fixtures to indirect lighting fixtures, thereby enhancing the aesthetics of an artificially illuminated environment and increasing the comfort of users in such an environment. Compared to alternative implementations comprising light fixture replacement, the technology specified herein presents reduced time, money, and skill barriers for users, is highly modular for simple user customization, and can be cleanly installed, adjusted, and removed without damage to the pre-existing light fixture, the attachment surface, or the apparatus.

In an example embodiment, a light diffusion apparatus comprises a ring portion including one or more hangers removably attachable to a light fixture having a light source with directed light, and a diffusion disk removably insertable into the ring portion, where in the diffusion disk is retained in the directed light from the light source.

In another example embodiment, a light diffusion apparatus comprises: a ring portion comprising an upper ring portion having a first outer peripheral wall defined by a first diameter and a lower ring portion having a second outer peripheral wall defined by a second diameter, wherein the second diameter is greater than the first diameter; one or more hangers removably attachable to a light fixture having a light source with directed light, wherein the one or more hangers are connected to the ring portion; and a diffusion disk fitted between the upper ring portion and the lower ring portion, and retained in the directed light from the light source.

In another example embodiment, a method of reversibly converting direct light to indirect light comprises: providing a fixed direct light source and providing a removable light diffusion apparatus comprising a ring portion comprising an upper ring portion having a first outer peripheral wall defined by a first diameter, a lower ring portion having a second outer peripheral wall defined by a second diameter, wherein the second diameter is greater than the first diameter, one or more hangers removably attachable to the fixed light source wherein the one or more hangers are connected to the ring portion, and a diffusion disk fitted between the upper ring portion and the lower ring portion, and retained in the directed light from the direct light source.

Various embodiments of the present invention may also contain one or more of the following features. The ring portion comprises: an upper ring portion having a first outer peripheral wall defined by a first diameter; a lower ring portion having a second outer peripheral wall defined by a second diameter, wherein the second diameter is greater than the first diameter; and a diffusion disk fitted between the upper ring and the lower ring. The ring portion has a first diameter and further comprises a halo portion positioned over the ring portion and the diffusion disk, the halo portion having a second diameter equal to or greater than the first diameter of the ring portion. In some embodiments, the diffusion disk is comprised of light diffusion material, light reflective material, light refractive material. In some embodiments, the diffusion disk is flat, concave or convex. In some embodiments, the diffusion disk includes one or more orifices. In some embodiments, the halo portion is comprised of light diffusion material. In some embodiments, the one or more hangers include a hinge and are moveable from a first position to a second position. In some embodiments, the one or more hangers include a spring biased hinge that mechanically biases the one or more hangers to a first position. In some embodiments, the light diffusion apparatus further comprises a halo portion positioned over the ring portion and the diffusion disk, the halo portion having a diameter equal to or greater than the diameter of the ring portion. In some embodiments, the hanger portions are moveable from a first biased position to a second position.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of an installed recessed lighting fixture.

FIG. 2 is a perspective view of an implementation of the present invention installed to a recessed light fixture.

FIG. 3 a front view of an implementation of the present invention installed to a recessed light fixture.

FIG. 4 is a perspective view of a disassembled implementation of the present invention.

FIG. 5 is an example implementation of the present invention.

FIG. 6 is an example implementation of the present invention.

FIG. 7 is an example implementation of the present invention.

FIG. 8 is an example implementation of the present invention.

FIG. 9 is an example implementation of the present invention.

FIG. 10 is an example implementation of the present invention.

### DETAILED DESCRIPTION

The following description is of one exemplary embodiment of the invention. The description is not to be taken in a limiting sense, but is made for the purpose of illustrating the general principles of the invention. Various inventive features are described below that can each be used independently of one another or in combination with other features.

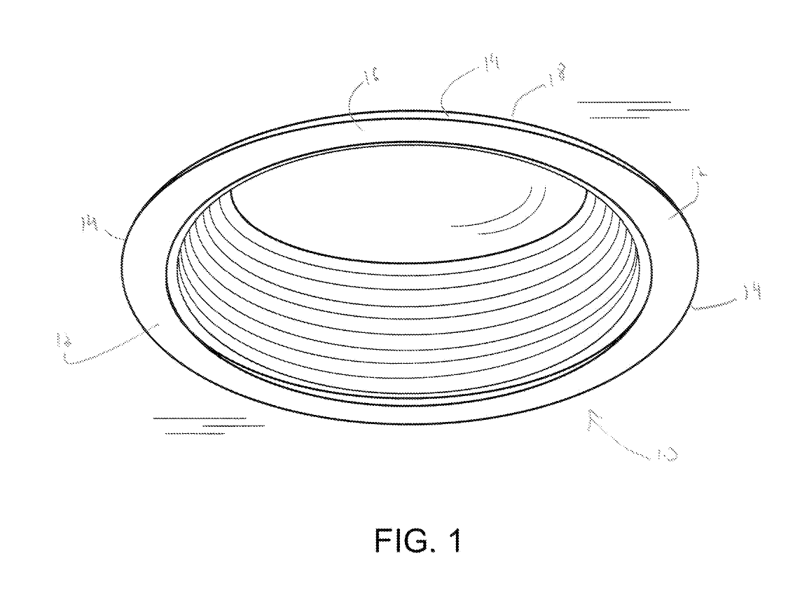

Broadly, an embodiment of the invention provides a light softening apparatus that can be used in conjunction with a pre-existing light fixture, such as a recessed ceiling mount “can” light. FIG. 1 illustrates a mounted recessed light fixture 10, such as a typical recessed can light. Light fixture 10 includes a peripheral edge portion 12, which can be integral to the fixture or can be a separate piece added as an aesthetic finish to cover the hole or cutaway made for the light fixture. In some embodiments, peripheral edge portion 12 is flush with the ceiling outer surface, in other embodiments peripheral edge portion 12 extends away from the ceiling outer surface. Peripheral edge portion 12 includes outer lip 14, lower surface 16, and upper surface 18. In some embodiments, lower surface 16 and outer lip 14 are visible when light fixture 10 is installed. Upper surface 18 may not be visible when light fixture 10 is installed, and may be adjacent or abutt the ceiling outer surface. In some embodiments, peripheral edge portion 12 is attached to light fixture 10 such that upper surface 18 can be freely moved away from the ceiling surface without displacing the light fixture.

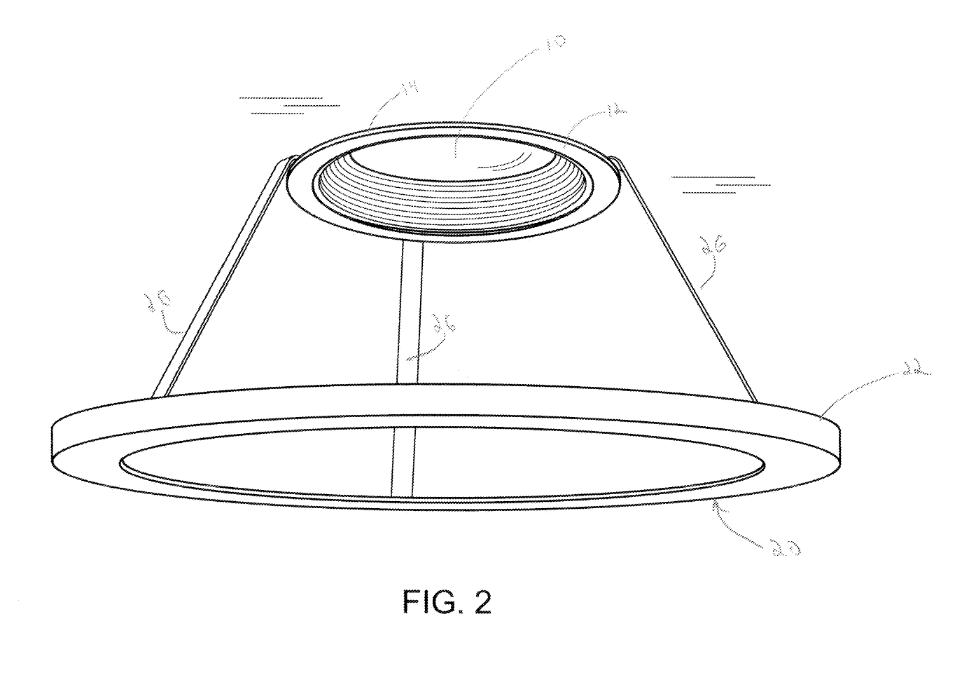

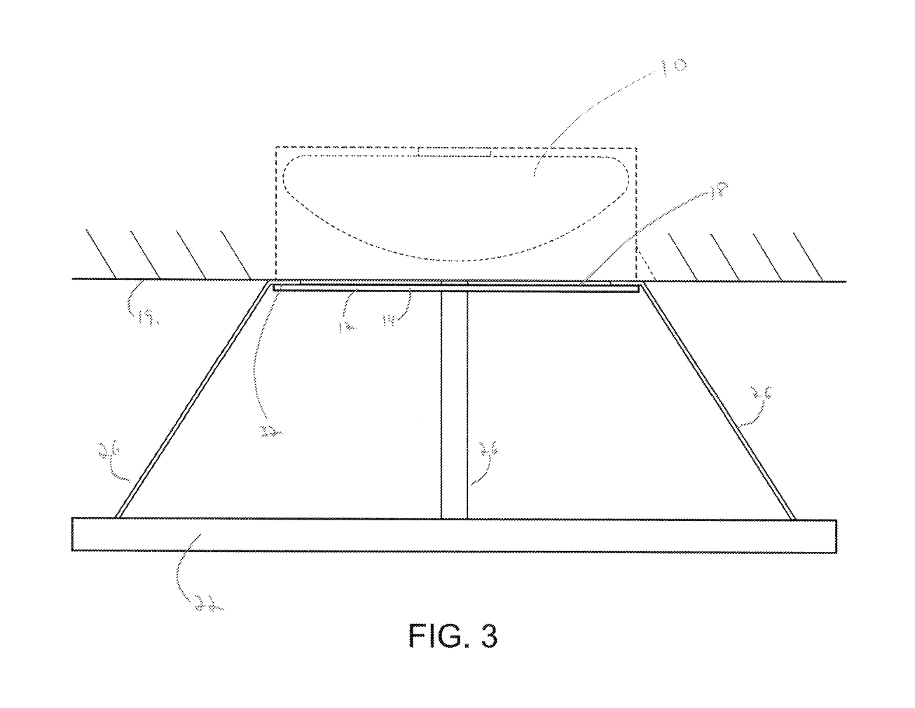

FIG. 2 illustrates an example implementation of the present invention wherein light diffusing apparatus 20 comprises upper ring 22 and multiple hangers 26. With reference to FIG. 3, light diffusing apparatus is depicted in a side, cut away view wherein multiple hangers 26 extend from upper ring 22 upwardly and insert behind and above peripheral edge portion 12 of recessed light 10 via hanger support tab 32. In one implementation hanger support tab 32 is in contact with the upper surface 18 and the ceiling outer surface 19. The multiple hangers can be removably mounted to the recessed light fixture in such a manner.

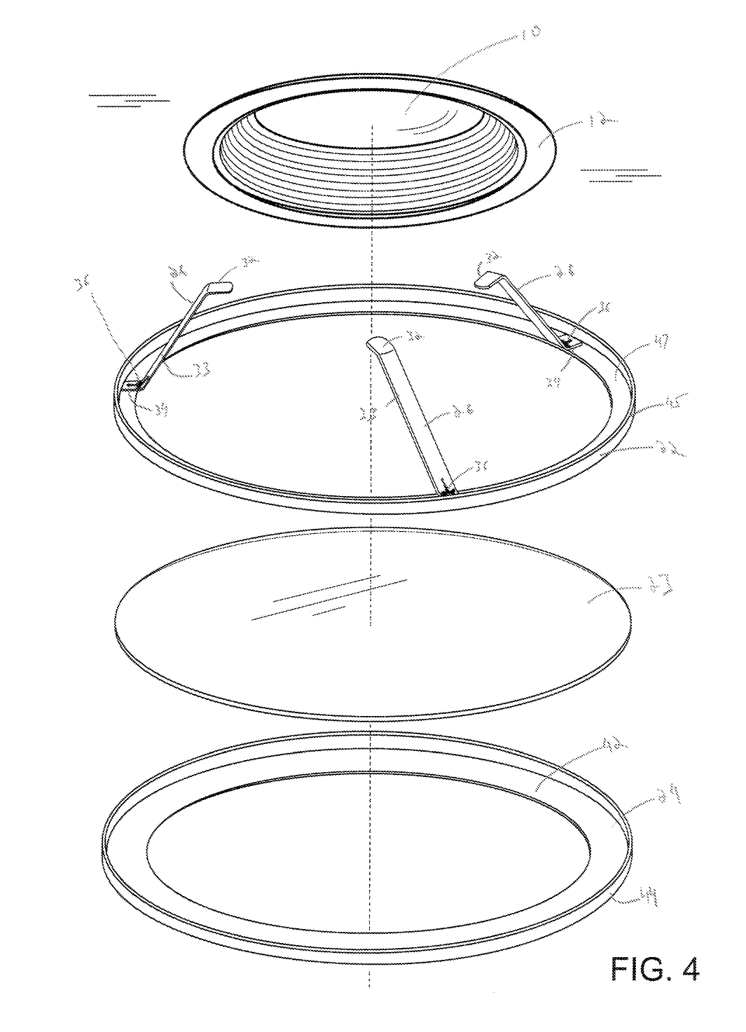

FIG. 4 illustrates various components of an implementation of the present invention wherein light diffusing apparatus comprises upper ring 22 having multiple hangers 26, diffusing disk 23, and lower disk retaining ring 24. In operation, diffusing disk 23 mounts with lower disk retaining ring 24 on ring surface 42 and radially inward from disk retention wall 44. Lower disk retaining ring is sized to attach in a secure but removable manner to upper ring 22. In one example implementation upper ring 22 has an outer peripheral wall 45 having a first outer diameter. Lower disk retaining ring 24 includes disk retention wall 44 having an inside diameter that is slightly larger than the outside diameter of the outer peripheral wall 45 of the upper ring 22 so as to allow the lower disk retaining ring to secure around and under the upper ring while simultaneously holding diffusing disk 23 in place. Other securing means are contemplated including raised lips, friction, adhesion, buckles, snaps and the like.

As discussed above, upper ring 22 includes multiple hangers 26. Each hanger 26 comprises hanger support tab 32, a riser 33, and a mounting tab 34. Mounting tab 34 can be fixedly secured to the upper ring 22 radially inward from outer peripheral wall 45, such as upper ring mounting surface 47. In some implementations a joint 36 is mounted between mounting tab 34 and riser 33. Joint 36 can be a flexible joint, a hinge, a spring, or the like. In some further implementations, joint 36 can create a spring-biased first position wherein the multiple hangers 26 are movable from a first position to a second position for installation. The multiple hangers can be spring-biased to the first position such that the multiple hangers extend substantially radially inward from the upper ring 22 and lie substantially flat in the disk plane defined by upper ring 22. The multiple hangers can be lifted to a second position, illustrated in FIG. 4 for installation. The spring-bias of the hinge 36 creates a retaining force for the diffusion apparatus 20 when installed into recessed light 10.

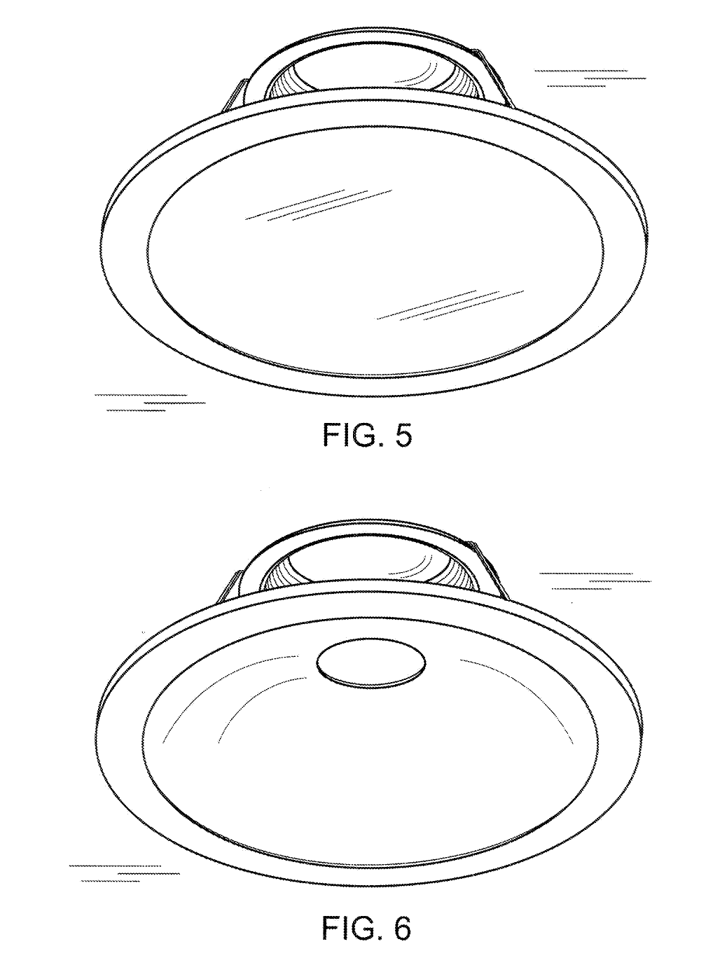

FIGS. 5 and 6 illustrate additional example embodiments of the present invention including light apparatus installed with a flat, solid diffusion disk 23 (FIG. 5) or a diffusion disk having a concave or domed shape and a central orifice (FIG. 6). In alternate embodiments diffusion disk 23 can be substantial flat and include a central orifice. The orifice can be any shape, round, oval, polygonal, and the like. The orifice can include a filler material of a different diffusion density than the remainder of the diffusion disk. The orifice can be centered or off center. In some embodiments, diffusion disk 23 can be plastic, glass, ceramic, metal, wood or paper. In other embodiments, diffusion disc 23 may be made of a clear, translucent, opaque, patterned, unpatterned, matte, glossy, and/or reflective material. In other embodiments, diffusion disc 23 may be other shapes, such as a square, a rectangle, pentagon, a polygon with N sides, an ellipse, or an irregular shape. In other embodiments, diffusion disc 23 may be of a non-flat volume. In other embodiments, diffusion disc 23 may be of a convex or concave volume. In some embodiments, diffusion disk 23 can include multiple orifices, or be porous. All or portions of diffusion disk 23 can include a reflective material. The orifice depicted in various embodiments of the diffusion disk 23 may be other shapes, such as a square, a rectangle, pentagon, a polygon with N sides, an ellipse, or an irregular shape.

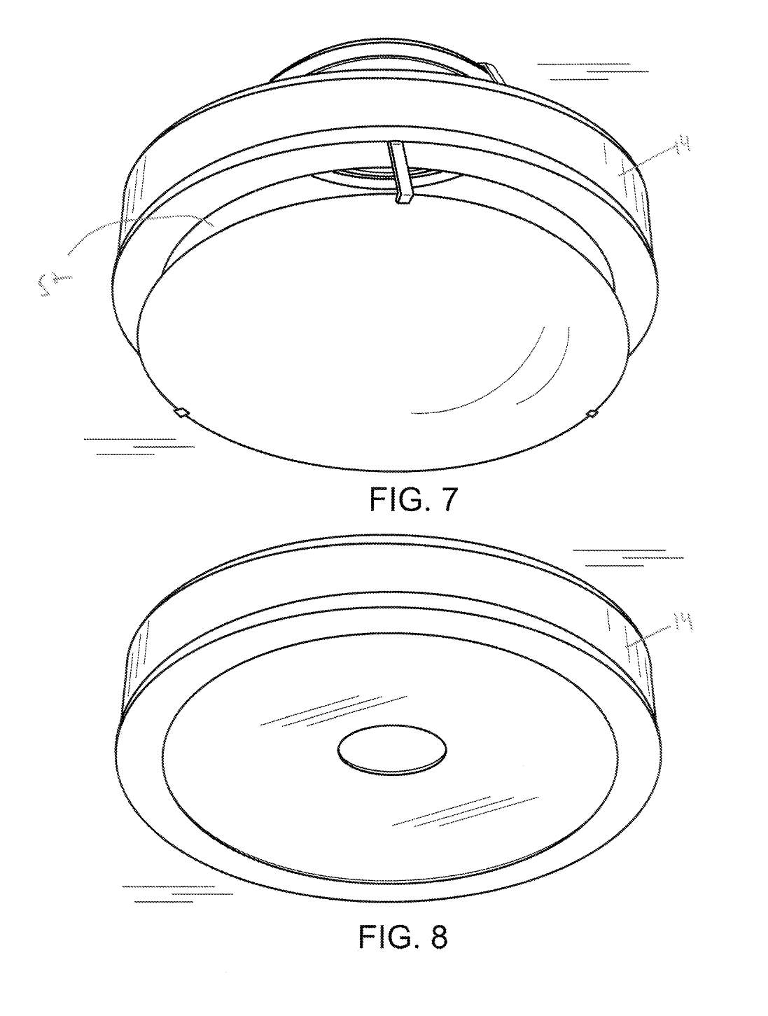

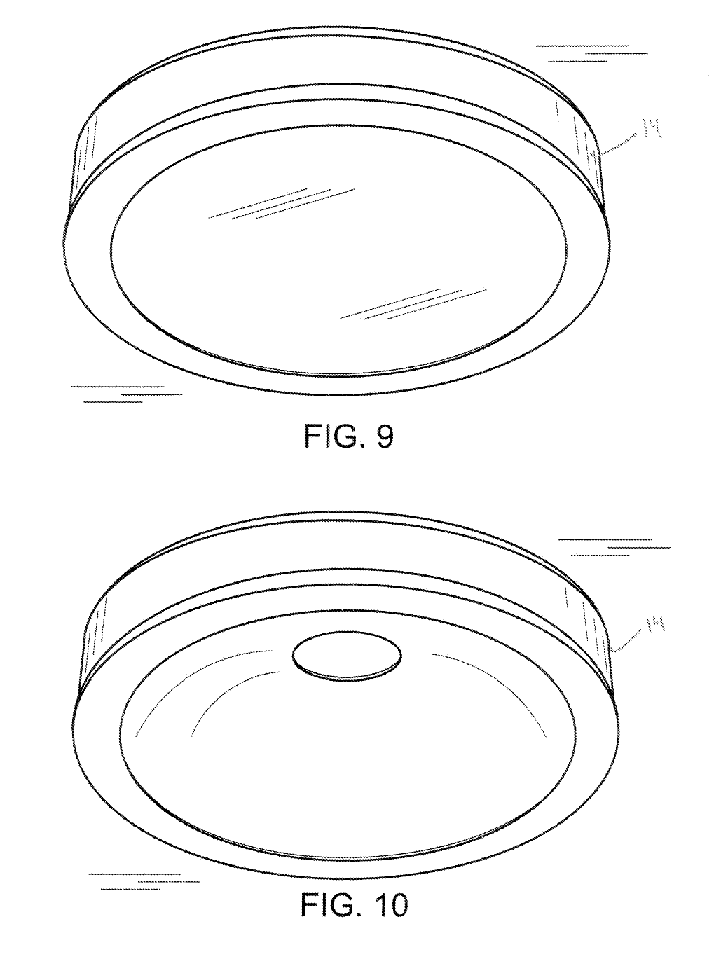

FIGS. 7-10 illustrate additional example implementations of the present invention including halo assemble 14. For example, light diffusion apparatus 20 can include halo assemble 14 positioned peripherally around upper ring 22, multiple hangers 26, diffusing disk 23, and lower disk retaining ring 24. In some embodiments a gap 52, can be between the lower portion of halo assembly 14 and the upper ring 22 (FIG. 7). In other embodiments the halo assembly 14 can be used with a diffusion disk 23, including an orifice to provide a combination of direct and diffuse light, (FIG. 8). In other embodiments, the halo assembly 14 can be provided with a diffusion disk 23 where no gap exists between the lower portion of halo assembly 14 and the upper ring 22 (FIG. 9). In still another embodiment, the halo assembly 14 can be used with a diffusion disk 23, including an orifice to provide a combination of direct and diffuse light, (FIG. 10), wherein the diffuse light is provide entirely via the halo assembly 14.

Further example embodiments include: The light diffusing apparatus comprises an upper ring, lower ring, disc insert, and halo assembly. To use light diffusion apparatus, the user places the diffusion disc into the lower ring such that it is held in place through friction against the outer wall. The upper ring is inserted into the lower ring, securing the diffusion disc through friction to the outer wall. The halo assembly is inserted above upper ring. The entire apparatus is secured below a recessed ceiling mount can light by inserting attachment tab(s) between the pre-existing can light collar ring and the ceiling. In such an embodiment, light from recessed light is diffused by the diffusion disk and the halo assembly.

In other embodiments, there may be any number of hangers or attachment arms. In other embodiments, attachment tabs 32 may have one or more holes to allow for attachment to a surface via nails or screws. In other embodiments, attachment tabs 32 may have adhesive, “Velcro,” or pointed surfaces to allow for alternative attachment to a surface.

Halo assembly 14 can comprise an open cylinder with one or more diffusion elements. In other embodiments, halo assembly 14 may be of other volumetric shapes, such as a cube, a rectangular prism, a pentagonal prism, a prismatoid with N sides, a polygonal with N faces, an ellipsoid, or an irregularly shape. In other embodiments, the halo assembly may have one or more openings, or no openings. In other embodiments, halo assembly 14 may not be included.

In various embodiments, diffuser disc 23 and/or halo assembly 14 are made of colored materials to produce colored light.

Elements of light diffusion apparatus 20 may be added, removed, or replaced to suit the user's application. In some embodiments, the diffuser disk 23 and halo assembly 24 are comprised of a diffuse material such that light from recessed light 10 is diffused from the bottom and sides of apparatus 20 when apparatus 20 is installed. In another embodiment, diffuser disc 23 is a convex volume comprised of a reflective material and Halo assembly 24 are comprised of a diffusive material such that light from light 23 is both reflected off of diffuser disc 23 towards the ceiling and diffused by halo assembly 14. In another embodiment, diffuser element 23 is comprised of an opaque material and halo assembly 14 is comprised of a diffusive material such that light is blocked from exiting the bottom of the apparatus and is diffused from the sides of the apparatus. In another embodiment, other combinations of desired constituent elements can be added, interchanged, or removed from apparatus 20 to suit the application.

In some embodiments, the light diffusion apparatus 20 may be designed to be attached to other types of light fixtures, such as “track” lights, non-recessed lights, ceiling fans, “disco balls,” spotlights, or floodlights. In such embodiments the multiple hangers can be modified to attach via the spring bias to various portions of the pre-existing light fixtures.

In some embodiments, the light diffusion apparatus 20 may be designed to be attached to surfaces of different orientations, such as fully vertical, fully horizontal, or some orientation in between.

In some embodiments, the light diffusion apparatus 20 may be designed to fit about more than one light or more than one light fixture.

In some embodiments, the light diffusion apparatus 20 may be designed to focus light using an appropriately designed diffuser disc 23 and/or halo assembly 14.

In some embodiments, the hangers/attachment arms 26 may be replaced by chains, fabrics, strings, ropes, yarns, or fibers.

In some embodiments, the light diffusion apparatus 20 may be designed to attach to objects other than a ceiling, such as a wall, a floor, an elevator, a ceiling fan, a stair, a vehicle, a portable lighting device, or a bar, a beam, or a column.

In some embodiments, diffusion disc 23 and lower ring 24 are held together by alternative means, such as through a bracket, a tab, a clasp, a snap, a hook, or an adhesive.

In some embodiments, upper ring 22 and lower ring 24 are held together by alternative means, such as through a bracket, a tab, a clasp, a snap, a hook, or an adhesive.

In some embodiments, hangers 26 and/or attachment tabs 32 may be replaced by one or more hooks, nail-like fasteners, or screw-like fasteners for attachment to the target object or surface.

In some embodiments, attachment tabs 32 may be replaced by one or more baffles, rings, or brackets to attach to the inside or outside of a light fixture enclosure.

A number of embodiments of the invention have been described. Nevertheless, it will be understood that various modifications may be made without departing from the spirit and scope of the invention. Accordingly, other embodiments are within the scope of the following claims.

What is claimed is:

1. A light diffusion apparatus comprising:
a ring portion comprising one or more hangers removably attachable to a light fixture having a light source with directed light,
a diffusion disk removably insertable into the ring portion, where in the diffusion disk is retained in the directed light from the light source.

2. The apparatus of claim 1 wherein the ring portion comprises:
an upper ring portion having a first outer peripheral wall defined by a first diameter;
a lower ring portion having a second outer peripheral wall defined by a second diameter, wherein the second diameter is greater than the first diameter; and
a diffusion disk fitted between the upper ring and the lower ring.

3. The apparatus of claim 1 wherein the ring portion has a first diameter and further comprising a halo portion position over the ring portion and the diffusion disk, the halo portion having a second diameter equal to or greater than the first diameter of the ring portion.

4. The apparatus of claim 1 wherein the diffusion disk is comprised of light diffusion material, light reflective material, or light refractive material.

5. The apparatus of claim 1 wherein the diffusion disk is flat, concave or convex.

6. The apparatus of claim 1 wherein the diffusion disk includes one or more orifices.

7. The apparatus of claim 3 wherein the halo portion is comprised of light diffusion material.

8. The apparatus of claim 1 wherein the one or more hangers include a hinge and are moveable from a first position to a second position.

9. The apparatus of claim 8 wherein the one or more hangers include a spring biased hinge that mechanically biases the one or more hangers to a first position.

10. A light diffusion apparatus comprising:
a ring portion comprising;
an upper ring portion having a first outer peripheral wall defined by a first diameter;
a lower ring portion having a second outer peripheral wall defined by a second diameter, wherein the second diameter is greater than the first diameter;
one or more hangers removably attachable to a light fixture having a light source with directed light; wherein the one or more hangers are connected to the ring portion; and
a diffusion disk fitted between the upper ring portion and the lower ring portion, and retained in the directed light from the light source.

11. The apparatus of claim 10 wherein the ring portion has a first diameter and further comprises a halo portion position over the ring portion and the diffusion disk, the halo portion having a second diameter equal to or greater than the first diameter of the ring portion.

12. The apparatus of claim 10 wherein the diffusion disk is comprised of light diffusion material, light reflective material, or light refractive material.

13. The apparatus of claim 10 wherein the diffusion disk is flat, concave or convex.

14. The apparatus of claim 10 wherein the diffusion disk includes one or more orifices.

15. The apparatus of claim 11 wherein the halo portion is comprised of light diffusion material.

16. The apparatus of claim 10 wherein the one or more hangers include a hinge and are moveable from a first position to a second position.

17. The apparatus of claim 16 wherein the one or more hangers include a spring biased hinge that mechanically biases the one or more hangers to a first position.

18. A method of reversibly converting direct light to indirect light comprising:
providing a fixed direct light source;
providing a removable light diffusion apparatus comprising;
a ring portion comprising;
an upper ring portion having a first outer peripheral wall defined by a first diameter;
a lower ring portion having a second outer peripheral wall defined by a second diameter, wherein the second diameter is greater than the first diameter;
one or more hangers removably attachable to the fixed light source wherein the one or more hangers are connected to the ring portion; and
a diffusion disk fitted between the upper ring portion and the lower ring portion, and retained in the directed light from the direct light source.

19. The method of claim 18 wherein the light diffusion apparatus further comprises a halo portion positioned over the ring portion and the diffusion disk, the halo portion having a diameter equal to or greater than the diameter of the ring portion.

20. The method of claim 18 wherein the hanger portions are moveable from a first biased position to a second position.
